(19) United States
(12) Patent Application Publication
(10) Pub. No.: US 2017/0089357 A1
(43) Pub. Date: Mar. 30, 2017

(54) COMPRESSOR HOUSING WITH VARIABLE DIAMETER DIFFUSER

(71) Applicant: BorgWarner Inc., Auburn Hills, MI (US)

(72) Inventor: CRAIG A. COLONT, CANDLER, NC (US)

(21) Appl. No.: 15/315,913

(22) PCT Filed: May 29, 2015
(86) PCT No.: PCT/US15/33097

§ 371 Date: Dec. 2, 2016

Related U.S. Application Data
(60) Provisional application No. 62/010,614, filed on Jun. 11, 2014.

(51) Int. Cl. F04D 29/46; F04D 29/28; F02B 37/22; F04D 25/04; F01D 5/04; F04D 29/42; F04D 29/053

(52) U.S. Cl. CPC F04D 29/464; F04D 29/4206; F04D 29/284; F04D 29/053; F04D 25/045; F01D 5/04; F02B 37/225; F05D 2220/40

(57) ABSTRACT

A turbocharger includes a compressor section (3). The compressor section (3) includes a compressor wheel (5), and a housing (12) that surrounds the compressor wheel (5). The housing (12) defines an air inlet (16) that is aligned with the rotational axis (R), an air outlet (18) in fluid communication with the air inlet (16), a volute (14) that provides a portion of a fluid path between the air inlet (16) and the air outlet (18). A variable diameter diffuser (7) extends radially between the compressor wheel (5) and the volute (14), and is defined between an adjustable diffuser wall assembly (30) and a facing surface (17a) of the compressor housing (12).

### CROSS-REFERENCE TO RELATED APPLICATIONS

This application claims priority to and all the benefits of U.S. Provisional Application No. 62/010,614, filed on Jun. 11, 2014, and entitled “Compressor Housing With Variable Diameter Diffuser,” the subject matter of which is incorporated herein by reference.

### FIELD OF THE INVENTION

The invention relates to a turbocharger with an improved compressor and more particularly, to a compressor having a variable diameter diffuser.

### BACKGROUND

Exhaust gas turbochargers are provided on an engine to deliver air to the engine intake at a greater density than would be possible in a normal aspirated configuration. This allows more fuel to be combusted, thus boosting the engine's horsepower without significantly increasing engine weight.

Generally, an exhaust gas turbocharger includes a turbine section and a compressor section, and uses the exhaust flow from the engine exhaust manifold, which enters the turbine section at a turbine inlet, to drive a turbine wheel located in the turbine housing. The turbine wheel drives a compressor wheel located in the compressor section via a shaft that extends between the sections. Air compressed by the compressor section is then provided to the engine intake as described above.

The compressor section of the turbocharger includes the compressor wheel and its associated compressor housing. Filtered air is drawn axially into a compressor air inlet which defines a passage extending axially to the compressor wheel. Rotation of the compressor wheel forces pressurized air flow radially outwardly from the compressor wheel into a compressor volute for subsequent pressurization and flow to the engine.

### SUMMARY

In some aspects, a compressor includes a compressor wheel and a housing that surrounds the compressor wheel. The housing defines an air inlet that is aligned with a rotational axis of the compressor wheel, an air outlet in fluid communication with the air inlet, and a volute that provides a portion of a fluid path between the air inlet and the air outlet. A variable diameter diffuser extends radially between the compressor wheel and the volute, and is defined between an adjustable diffuser wall assembly and a facing surface of the housing.

The compressor may include one or more of the following features: The diffuser wall assembly is configured to be adjustable between a first position in which the diffuser has a first diameter, and a second position in which the diffuser has a second diameter, and the second diameter is different than the first diameter. The diffuser wall assembly includes plates arranged about a circumference of the compressor wheel, wherein when diffuser wall assembly is in the first position, the plates are located at a first radial distance from the rotational axis, and when the diffuser wall assembly is in the second position, the plates are located at a second radial distance from the rotational axis, and the second radial distance is different than the first radial distance. The diffuser wall assembly includes overlapping plates that cooperate to define a wall of the diffuser, a stationary ring that supports the plates relative to the housing, and a movable ring that is concentric with the stationary ring, and is configured to engage each plate such that when the movable ring is rotated about the rotational axis relative to the stationary ring, the radial position of the plates is changed. The plates have a profile in the shape of a sector of an annulus. Each plate includes a flow surface that faces the facing surface, and an actuating surface that is opposed to the flow surface, and each plate has a thickness that is non-uniform along a circumference of the plate. Each plate includes a first slide surface formed on the flow surface, the first slide surface defining a first region of reduced plate thickness and extending between a first side edge of the plate and a first shoulder, a second slide surface formed on the actuating surface, the second slide surface defining a second region of reduced plate thickness and extending between a second side edge of the plate and a second shoulder, and wherein the plates are arranged in an overlapping manner about a circumference of the compressor wheel such that the first slide surface of one plate at least partially overlies the second slide surface of an adjacent plate, regardless of the position of the plates. Each plate includes an alignment slot and an actuating slot, the stationary ring includes first protrusions, and a first protrusion is received in the alignment slot of each plate, the movable ring includes second protrusions, and a second protrusion is received in the actuating slot of each plate. When the movable ring is rotated about the rotational axis, each second protrusion cooperates with a corresponding actuating slot to cause movement of a corresponding plate, and each first protrusion is configured to cooperate with a corresponding alignment slot to direct the movement of the plate in a radial direction.

In some aspects, a turbocharger includes a turbine section including a turbine wheel, a compressor section including a compressor wheel, and a shaft connecting the turbine wheel to the compressor wheel. The compressor section further includes a housing that surrounds the compressor wheel and defines an air inlet that is aligned with a rotational axis of the shaft, an air outlet in fluid communication with the air inlet, and a volute that provides a portion of a fluid path between the air inlet and the air outlet, and a variable diameter diffuser that extends radially between the compressor wheel and the volute, and is defined between an adjustable diffuser wall assembly and a facing surface of the housing.

The turbocharger may include one or more of the following features: The diffuser wall assembly is configured to be adjustable between a first position in which the diffuser has a first diameter, and a second position in which the diffuser has a second diameter, and the second diameter is different than the first diameter. The diffuser wall assembly includes overlapping plates that cooperate to define a wall of the diffuser, a stationary ring that supports the plates relative to the housing, and a movable ring that is concentric with the stationary ring, and is configured to engage each plate such that when the movable ring is rotated about the rotational axis relative to the stationary ring, the radial position of the plates is changed. The plates have a profile in the shape of a sector of an annulus. Each plate includes a flow surface that faces the facing surface, and an actuating surface that is opposed to the flow surface, and each plate has a thickness that is non-uniform along a circumference of the plate. Each plate includes a first slide surface formed on the flow surface, the first slide surface defining a first region of reduced plate thickness and extending between a first side edge of the plate and a first shoulder, a second slide surface formed on the actuating surface, the second slide surface defining a second region of reduced plate thickness and extending between a second side edge of the plate and a second shoulder, and wherein the plates are arranged in an overlapping manner about a circumference of the compressor wheel such that the first slide surface of one plate at least partially overlies the second slide surface of an adjacent plate, regardless of the position of the plates. Each plate includes an alignment slot and an actuating slot, the stationary ring includes first protrusions, and a first protrusion is received in the alignment slot of each plate, the movable ring includes second protrusions, and a second protrusion is received in the actuating slot of each plate, when the movable ring is rotated about the rotational axis, each second protrusion cooperates with a corresponding actuating slot to cause movement of a corresponding plate, and each first protrusion is configured to cooperate with a corresponding alignment slot to direct the movement of the plate in a radial direction.

The turbocharger compressor is designed to help increase the intake manifold pressure and density to allow the engine cylinders to ingest a greater mass of air during each intake stroke. The turbocharger compressor includes a variable diameter diffuser to permit adjustment and control of the diameter of the diffuser, which directly affects the performance characteristics of the compressor section. In this regard, a compressor map is used to predict the performance of the compressor. The compressor map is a graph of the pressure ratio (Pₑₓᵢₜ/Pᵢₙₗₑₜ) versus compressor inlet air flow (mass/time). The compressor performance map defines, based on inlet conditions, the usable operating characteristics of the compressor in terms of airflow and pressure ratio. Two different sets of curves are provided on the map: compressor efficiency curves and compressor wheel rotational speed (rpm) curves. The area where there are curves drawn defines an operating envelope.

The turbocharger compressor includes a diffuser surface that is formed of overlapping sector-shaped plates arranged about the circumference of the compressor wheel, and the plates are configured to move radially outward, whereby the diameter of the diffuser can be adjusted. The variable diameter diffuser is configured to permit adjustment of the diffuser diameter during engine operation. In particular, the diameter of the compressor diffuser can be enlarged or contracted in order to affect compressor performance including the location of peak efficiency and width of the operating envelope on a compressor map. As a result, the compressor stage can be made to better fit engine operating requirements at both high and low engine speeds, making it easier for a single compressor stage to deliver both low-engine speed torque and peak power requirements of the engine.

Other objects and purposes of the invention, and variations thereof, will be apparent upon reading the following specification and inspecting the accompanying drawings.

### BRIEF DESCRIPTION OF THE DRAWINGS

FIG. 1 schematic cross-sectional view of an exhaust gas turbocharger connected to an engine.

FIG. 2 is an axial end view of a compressor section of the turbocharger of FIG. 1.

FIG. 3 is a cross-sectional view along line 3-3 of FIG. 2 with the diffuser wall assembly in the minimum diameter position.

FIG. 4 is a cross-sectional view along line 3-3 of FIG. 2 with the diffuser wall assembly in the maximum diameter position.

FIG. 5 is a perspective view of a plate of the diffuser wall assembly.

FIG. 6 is a side view of the plate of FIG. 5 showing the actuating surface.

FIG. 7 is an end view of the plate of FIG. 5 showing the inner edge surface.

FIG. 8 is side view of the plate of FIG. 5 showing the flow surface.

FIG. 9 is an exploded view of a pair of adjacent plates.

FIG. 10 is an exploded view of the stationary ring and the movable ring.

FIG. 11 is a cross-sectional view of the diffuser wall assembly in the minimum diameter position as seen along line 11-11 of FIG. 3.

FIG. 12 is a cross-sectional view of the diffuser wall assembly in the maximum diameter position as seen along line 12-12 of FIG. 4.

FIG. 13 is an enlarged cross-sectional view of the portion of the diffuser wall assembly identified in FIG. 3 as “FIG. 13”.

FIG. 14 is an enlarged cross-sectional view of the portion of the diffuser wall assembly identified in FIG. 4 as “FIG. 14”

### DETAILED DESCRIPTION

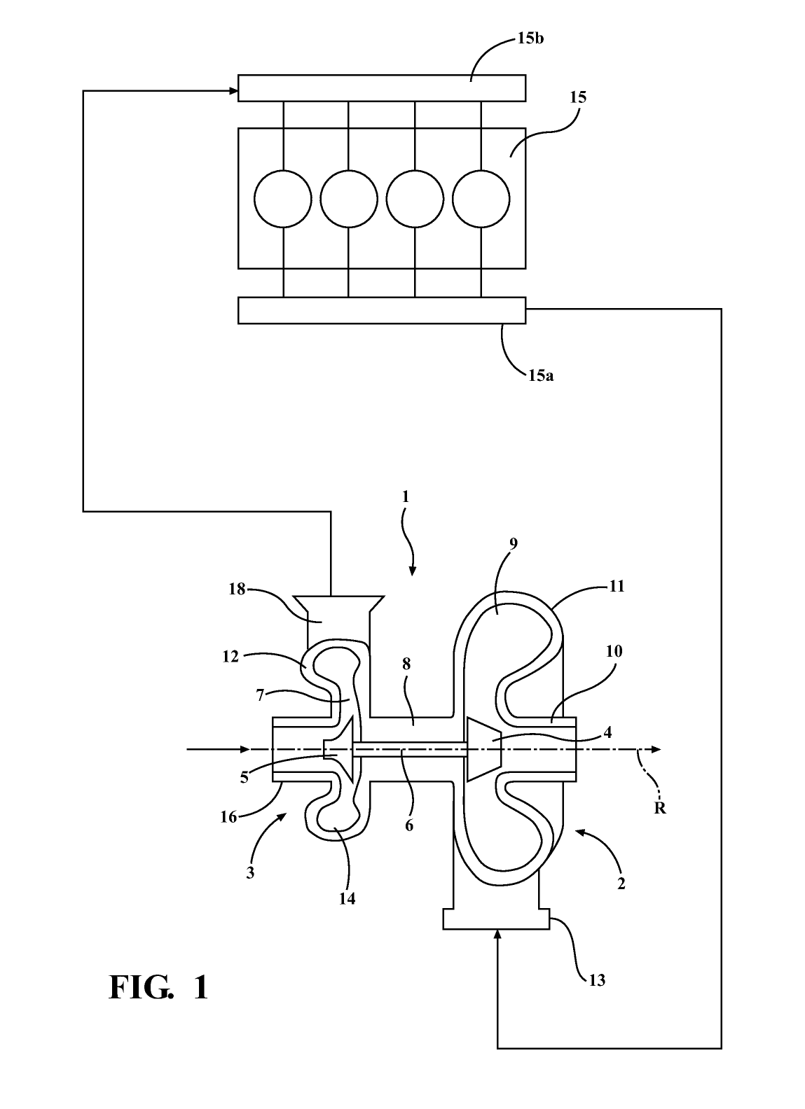

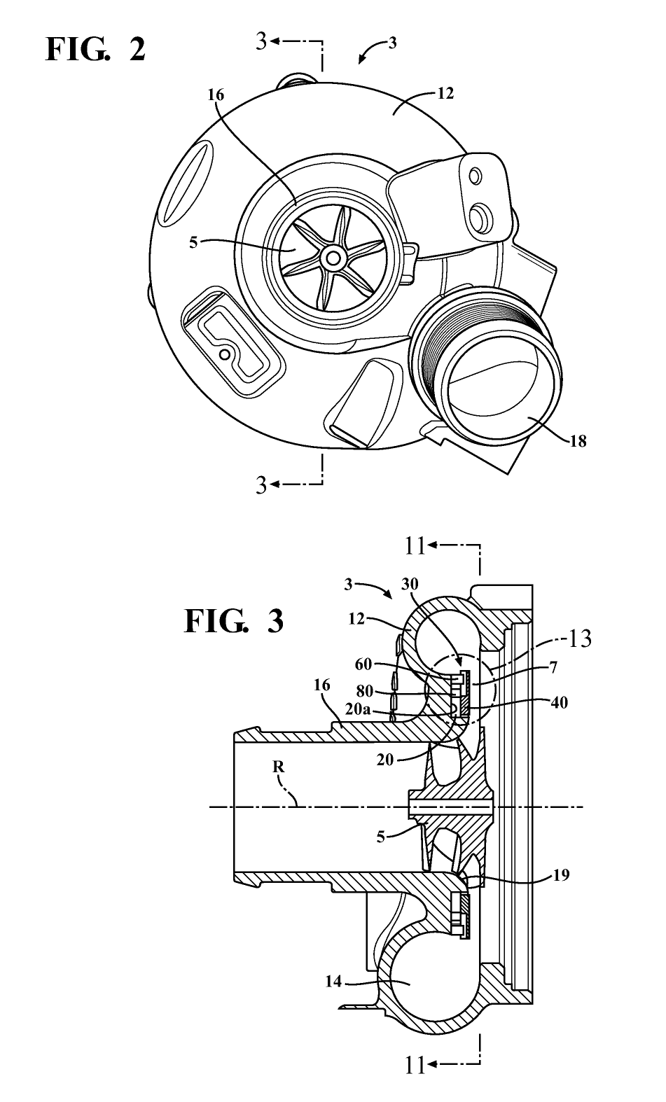

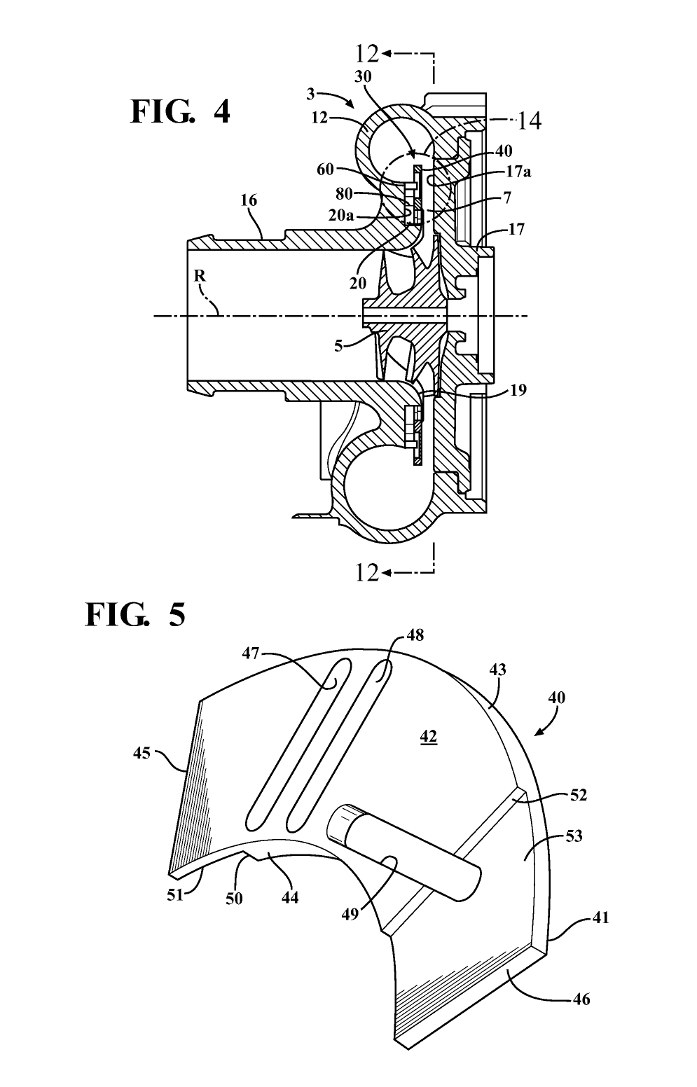

Referring to FIGS. 1-4, an exhaust gas turbocharger 1 includes a turbine section 2, the compressor section 3, and a center bearing housing 8 disposed between and connecting the compressor section 3 to the turbine section 2. The turbine section 2 includes a turbine housing 11 that defines an exhaust gas inlet 13, an exhaust gas outlet 10, and a turbine volute 9 disposed in the fluid path between the exhaust gas inlet 13 and exhaust gas outlet 10. A turbine wheel 4 is disposed in the turbine housing 11 between the turbine volute 9 and the exhaust gas outlet 10. A shaft 6 is connected to the turbine wheel 4, is supported for rotation about a rotational axis R within in the bearing housing 8, and extends into the compressor section 3. The compressor section 3 includes a compressor housing 12 that defines an axially-extending air inlet 16, an air outlet 18, and a compressor volute 14. A compressor wheel 5 is disposed in the compressor housing 12 between the air inlet 16 and the compressor volute 14 at a location, referred to as the contour 19, at which the air flow path makes a 90 degree turn. A diffuser 7 is defined between a surface 17a of the backplate 17 of the compressor housing 12 and a diffuser wall assembly 30 that is disposed in a groove 20 formed in the compressor housing 12 between the contour 19 and the volute 14 (FIG. 4). As used herein, the diffuser 7 refers to a parallel-walled, radially-extending air passageway that directs air flow from the axially-extending compressor air inlet 16 to the compressor volute 14.

In use, the turbine wheel 4 in the turbine housing 11 is rotatably driven by an inflow of exhaust gas supplied from the exhaust manifold 15a of an engine 15. Since the shaft 6 connects the turbine wheel 4 to the compressor wheel 5 in the compressor housing 12, the rotation of the turbine wheel 4 causes rotation of the compressor wheel 5. As the compressor wheel 5 rotates, it increases the air mass flow rate, airflow density and air pressure delivered to the engine's cylinders via an outflow from the compressor air outlet 18, which is connected to the engine's air intake manifold 15b.

The diffuser wall assembly 30 includes overlapping plates 40 that cooperate to define one of the two parallel walls of the diffuser 7, a stationary ring 60 that is disposed between the plates 40 and an axially-facing surface 20a of the groove 20, and supports the plates 40 within the groove 20, and a movable ring 80 that is disposed between the plates 40 and the axially-facing surface 20a of the groove 20 and is concentric with the stationary ring 60. The movable ring 80 is configured to rotate about the rotational axis R relative to the stationary ring 60 while engaging with the plates 40. When the movable ring 80 is rotated about the rotational axis R, the plates 40 are moved, for example between a first, minimum diameter position and a second, maximum diameter position. In the first, minimum diameter position, the ratio of diffuser diameter to compressor wheel diameter is, for example, 1.5 (FIG. 3). In the second, maximum diameter position, the diffuser diameter is enlarged relative to that of the first position, for example such that the ratio of diffuser diameter to compressor wheel diameter is 1.7 (FIG. 4). Thus, the diffuser wall assembly 30 permits the configuration of the plates 40, and thus the diffuser diameter, to be adjusted and controlled, as discussed further below.

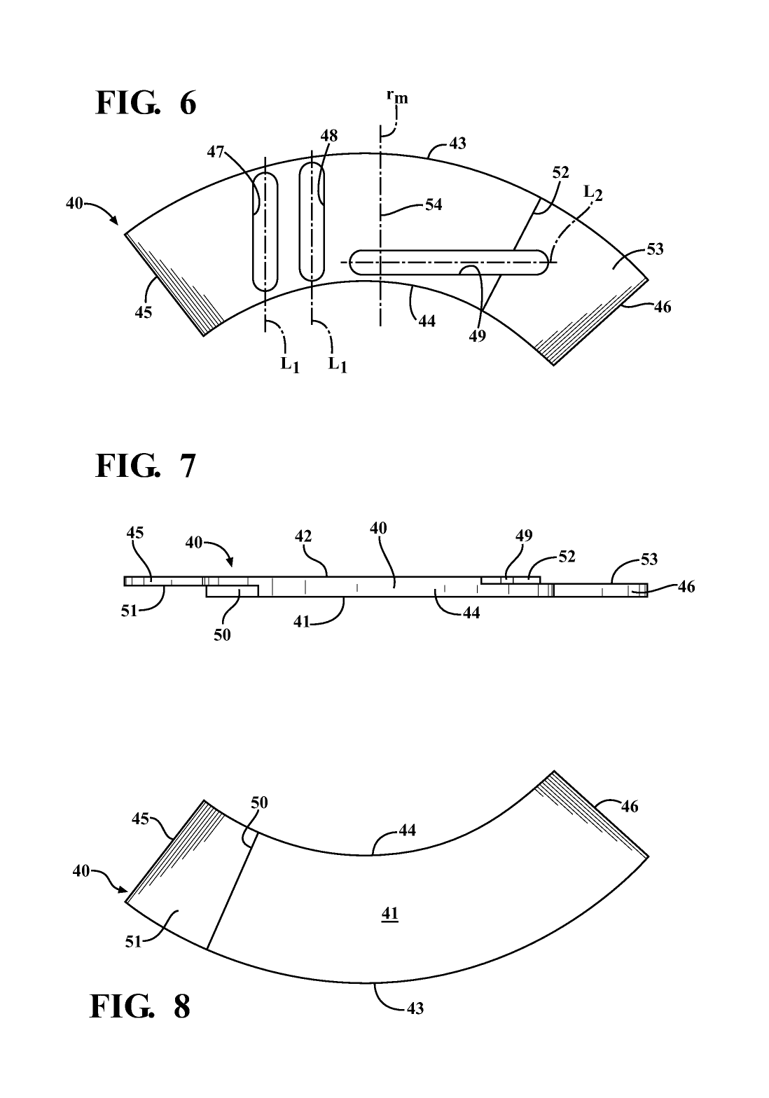

Referring to FIGS. 5-7, the diffuser wall assembly 30 includes five identical plates 40 arranged to form a generally planar annular wall surface. Each plate 40 includes a flow surface 41 that faces the diffuser surface 17a of the compressor housing backplate 17, and an actuating surface 42 that is opposed to the flow surface 41. In addition, when seen as viewed along the rotational axis R (FIGS. 6, 8), each plate 40 has a profile having the shape of a sector of an annulus. The profile is defined by a curved, radially outward-facing outer edge 43, a curved, radially inward-facing inner edge 44, a linear first side edge 45, and a linear second side edge 46 that is opposed to the first side edge 45. The outer edge 43 and the inner edge 44 are concentric, and centered on the rotational axis R. The first and second side edges 45, 46 are non-parallel and are each aligned with a radius of a circle defined by the inner edge 44.

Each plate 40 is thin, e.g., the thickness (distance between the flow surface and the actuating surface) of each plate 40 is small relative to its radial and circumferential dimensions. The plate thickness is non-uniform along a circumference of the plate 40 since each plate 40 includes a slide surface 51, 53 adjacent each of the first and second side edges 45, 46, Specifically, material is removed from the flow surface 41 adjacent to the first side edge 45, whereby a radially-extending first shoulder 50 is formed (FIGS. 7, 8). The first slide surface 51 extends between the first side edge 45 and the first shoulder 50, and faces the diffuser surface 17a of the compressor housing backplate 17. Similarly, material is removed from the actuating surface 42 adjacent to the second side edge 46, whereby a radially-extending second shoulder 52 is formed (FIGS. 6, 7). The second slide surface 53 extends between the second side edge 46 and the second shoulder 52, and faces the stationary and movable rings 60, 80.

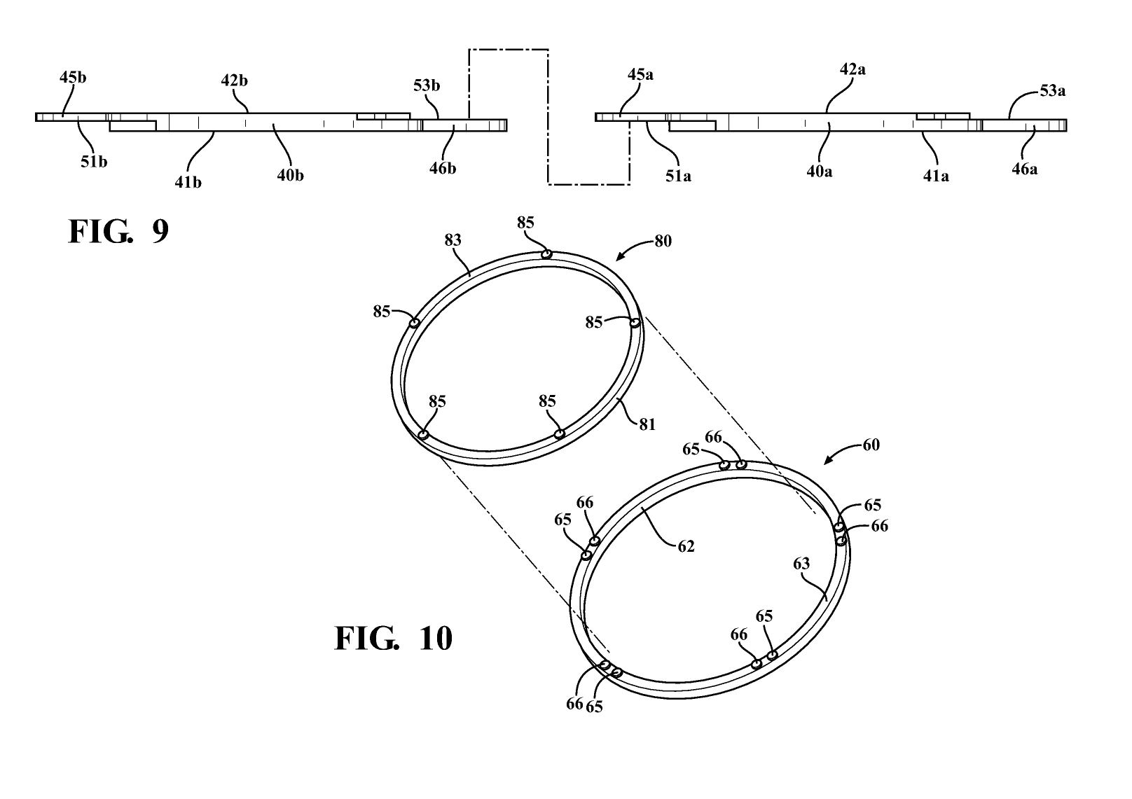

Referring to FIG. 9, the plates 40 are arranged about the circumference of the compressor wheel 5 such that the first slide surface 51a of one plate 40a at least partially overlies the second slide surface 53b of an adjacent plate 40b, regardless of the position of the plates 40. The circumferential dimension of the first and second slide surfaces 51, 53 is configured so that the plates 40 have at least some overlap regardless of the configuration of the diffuser wall assembly, and particularly so that there are no gaps between adjacent plates 40a, 40b when the plates 40 are in the second, maximum diameter position. The plate thickness in the vicinity of the first and second slide surfaces 51, 53 is set so that the total thickness of the overlapped plates in the vicinity of the first and second slide surfaces 51, 53 is the same as the thickness of a plate 40 between the first and second slide surfaces 51, 53.

The circumferential dimension of each plate 40 depends on the number of plates 40 employed and the amount of plate overlap required, In the illustrated embodiment which includes five plates, each plate 40 has a circumferential dimension corresponding to an arc length of 85 degrees.

Other than the first shoulder 50, the flow surface 41 of each plate 40 is free of surface features such as grooves, ridges or openings in order to minimize generation of air flow disturbances within the diffuser.

Referring again to FIGS. 5 and 6, each plate 40 includes a pair of parallel, elongated alignment slots 47, 48 disposed between the first side edge 45 and a circumferential mid-point 54 of the plate 40. The alignment slots 47, 48 are oriented such that a long axis L₁ of each alignment slot 47, 48 is generally parallel to a radius rₘ of the plate 40 that passes through the mid-point 54. The depth of the alignment slots 47, 48 is less than the thickness of the corresponding plate 40. Each alignment slot 47, 48 is shaped and dimensioned to receive an alignment pin 65, 66 that protrudes from the stationary ring 60, as discussed further below.

Each plate 40 includes an elongated actuating slot 49 disposed between the second side edge 46 and the mid-point 54 of the plate 40. The actuating slot 49 is oriented such that a long axis L₂ of the actuating slot 49 is generally perpendicular to the radius rₘ of the plate 40, The depth of the actuating slot 49 is less than the thickness of the corresponding plate 10. The actuating slot 49 is shaped and dimensioned to receive actuating pins 85 that protrude from the movable ring 80. The actuating slot 49 has a length that is sufficient to permit the corresponding actuating pin 85 to rotate through an arc, where the arc length is sufficient to achieve the desired change in diffuser diameter, as discussed further below. In the illustrated embodiment, the actuating slot 49 has a length that is sufficient to both intersect the radius rₘ and extend into the second slide surface 53.

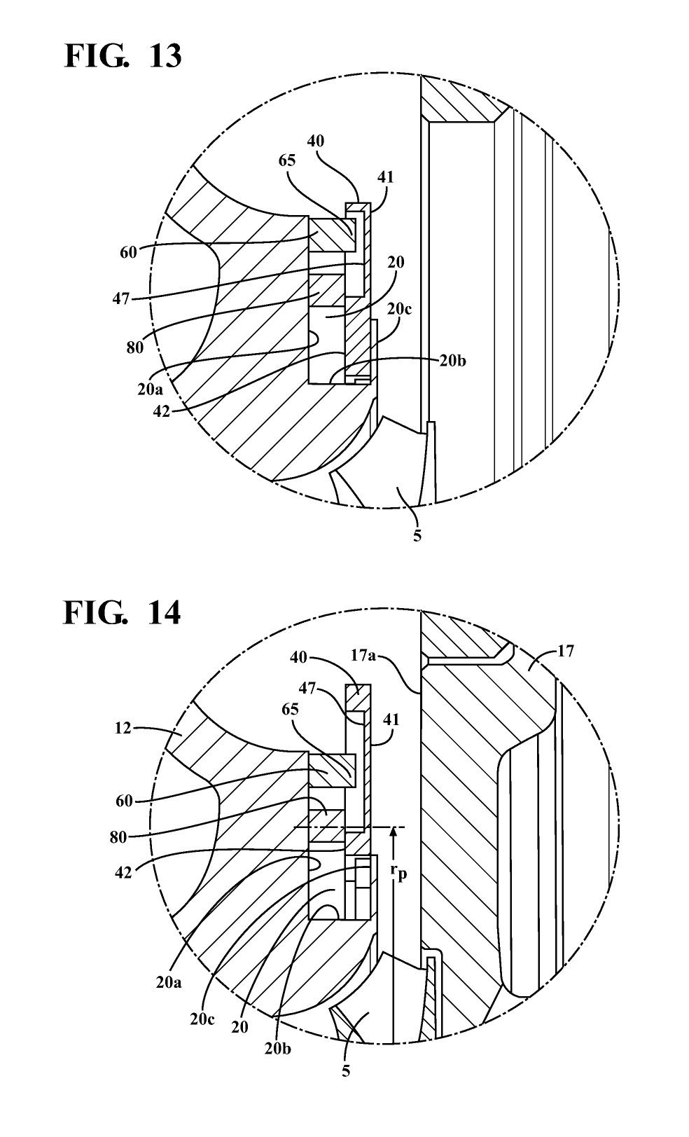

Referring to FIGS. 10 and 13, the stationary ring 60 is annular, and is fixed to the groove 20 of the compressor housing 12 so as to be centered on the rotational axis R via conventional means such as keying, press fit, adhesive or a combination thereof. The stationary ring 60 includes five pairs of alignment pins 65, 66 that protrude axially outward from a plate-facing surface 63 of the stationary ring 60 in a direction toward the plates 40. The pairs of alignment pins 65, 66 are equidistantly spaced apart along the place-facing surface 63 so that one pair of alignment pins 65, 66 is aligned with each plate 40. For a given plate 40, one alignment pin (e.g., pin 65) of the pair is received within one plate alignment slot (e.g., alignment slot 47), and the other alignment pin (e.g., pin 66) of the pair is received within the other plate alignment slot (e.g., alignment slot 48).

The movable ring 80 is annular, and is rotatably disposed in the groove 20 so as to be concentric with and surrounded by the stationary ring 60. The movable ring 80 is connected to an external actuation device (not shown) via a linkage (not shown), which drives the movable ring 80 to rotate within the groove 20 about the rotational axis R. The movable ring 80 includes the actuating pins 85 that protrude axially outward from a plate-facing surface 83 of the movable ring 80 in a direction toward the plates 40. The actuating pins 85 are equidistantly spaced apart along the plate-facing surface 83 so that one actuating pin 85 is aligned with each plate 40. For a given plate 40, the actuating pin 85 is received within, the corresponding actuating slot 49.

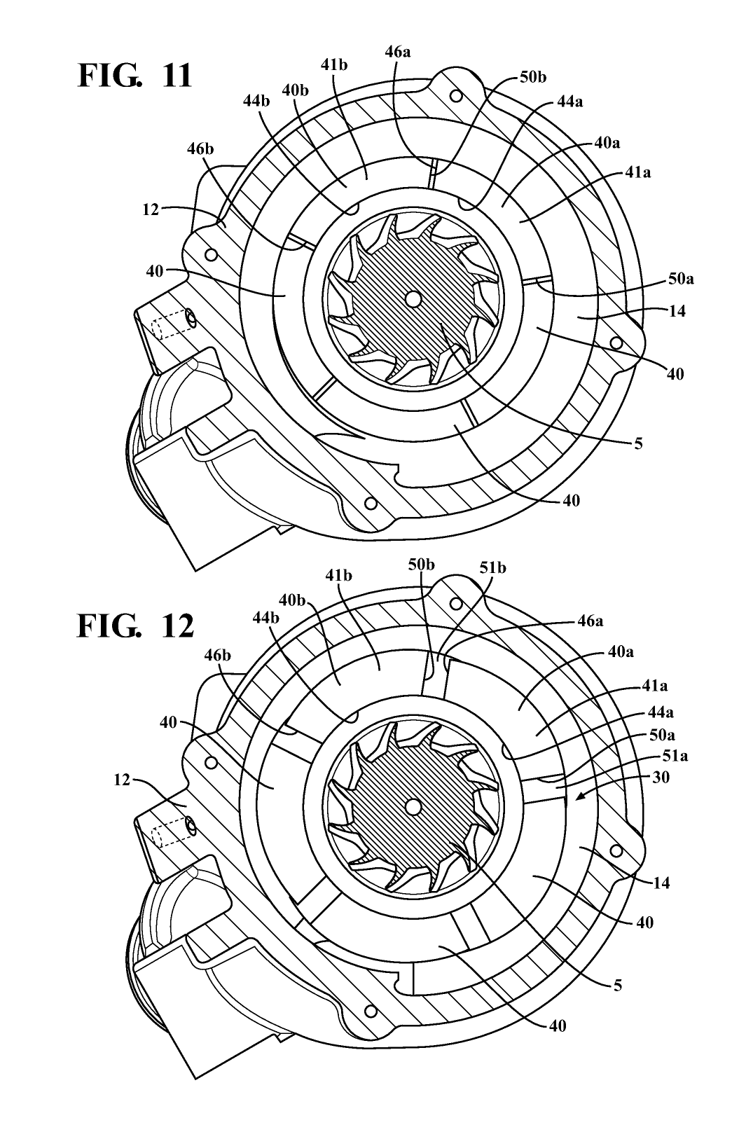

Referring to FIGS. 9, 11-14, as previously described, the diffuser wall assembly 30 includes five plates 40 arranged about the circumference of the compressor wheel 5 such that the first slide surface 51a of one plate 40a overlies the second slide surface 53b of an adjacent plate 40b, and so that the respective plate inner edges 44 describe a circle that surrounds the compressor wheel 5 (FIGS. 9, 11 and 12). The plates 40 are received within the groove 20 such that the plate inner edge 44 faces a radially outward facing surface 20b of the groove 20, in the minimum diameter position, a portion of the plate inner surface 41 confronts a radially extending flange 20c of the groove 20 (FIG. 13). The flange 20c is intended to create the base of the diffuser surface and to cover the inboard edges of the diffuser plates 40 so that there is not a circumferential gap between the contour 19 and the diffuser surface 41. The diffuser plates 40 are not necessarily retained within the groove 20 by the radially extending flange 20c of the groove 20, but could be in some embodiments. In addition, the actuating surface 42 of each plate 40 is closely spaced with the plate-facing surfaces 63, 83 of the stationary and movable rings 60, 80 such that the alignment pins 65, 66 are received in corresponding alignment slots 47, 48 and the actuating pins 85 are received within the corresponding actuating slots 49 (FIGS. 13 and 14). For example, when the diffuser watt assembly 30 is in the first, minimum diameter position (FIGS. 11 and 13), the alignment pins 65, 66 reside at the radially outermost part of the respective alignment slots 47, 48, and the actuating pins 85 reside at an end of the actuating slot 49 closest to the plate mid-point 54.

Motion of the plates 40 from the first position to the second, maximum diameter position (FIGS. 12 and 14) is accomplished via cooperation with the stationary ring 60 and the movable ring 80. For each plate 40, when the movable ring 80 is rotated, for example in a positive direction, about the rotational axis R relative to the stationary ring 60, each respective actuating pin 85 is moved along the actuating slot 49 toward the plate second side edge 46. Although the pin 85 moves along an arc shaped path corresponding to the radius of the movable ring 80, the corresponding plate 40 is prevented from rotating by the presence of the alignment pins 65, 66 in the corresponding alignment slots 47, 48. Instead, due to the orientation of the alignment slots 47, 48, the movement of the actuating pin 85 toward the plate second side edge 46 results in a radially outward movement of the plate 40 relative to the rotational axis R. Similarly, when the movable ring 80 is rotated, for example in a negative direction, about the rotational axis R relative to the stationary ring 60, the actuating pin 85 is moved toward the plate first side edge 45, which results in a radially inward movement of the plate 40 relative to the rotational axis R.

The change in diffuser diameter (d) can be calculated by the following equation:

d=2rₚ(1−cos □)

In this equation, rₚ corresponds to the radius from the center of the actuating pin 85 to the rotational axis R and □ is the angle of rotation through which the movable ring 80 moves. This equation can also be solved tier the required angle of rotation to achieve a known desired change in diffuser diameter, and thus can be used to design the correct length for the actuating slot 49.

In the illustrated embodiment, the diffuser wall assembly 30 includes five plates 40 arranged about the circumference of the compressor wheel 5. However, the diffuser wall assembly 30 can include a greater or fewer number of plates 40 depending on the specifics of the application, as well as a cost-benefit determination between the benefits of increasing the number of plates 40 to provide a more uniform, circular profile of the plate assembly in the maximum outward position, and the cost of increasing the number of parts in the overall assembly in terms of manufacture, assembly, and reliability.

The diffuser wall assembly 30 is described herein as including a stationary ring 60 having pairs of alignment pins 65, 66 that cooperate with corresponding alignment slots 47, 48 of the plates 40 to prevent rotation of the plates 40 during movement of the diffuser wall assembly 30 between the first and second positions. The illustrated example includes two alignment slots 47, 48 that interface with round alignment pins 65, 66, but is not limited to this configuration. For example, in some embodiments a single alignment slot can interface with a square pin.

In the illustrated embodiments, the diffuser 7 is defined between a surface 17a of the backplate 17 of the compressor housing 12 and a diffuser wall assembly 30. Typically, the backplate 17 of the compressor housing 12 is formed separately from the compressor housing 12 for manufacturing purposes. Moreover, the diffuser 7 is not limited to this configuration. For example, in some embodiments, the diffuser 7 is defined between a facing surface of the center bearing housing 8 and the diffuser wall assembly 30.

Although particular preferred embodiments of the invention have been disclosed in detail for illustrative purposes, it will be recognized that variations or modifications of the disclosed apparatus, including the rearrangement of parts, lie within the scope of the present invention.

I claim:

1. A compressor (3) comprising
a compressor wheel (5); and
a housing (12) that surrounds the compressor wheel (5) and defines
an air inlet (16) that is aligned with a rotational axis (R) of the compressor wheel (5),
an air outlet (18) in fluid communication with the air inlet (16), and
a volute (14) that provides a portion of a fluid path between the air inlet (16) and the air outlet (18),
wherein a variable diameter diffuser (7) extends radially between the compressor wheel (5) and the volute (14), and is defined between an adjustable diffuser wall assembly (30) and a facing surface (17a) of the housing (12).

2. The compressor (3) of claim 1, wherein the diffuser wall assembly (30) is configured to be adjustable between a first position in which the diffuser (7) has a first diameter, and a second position in which the diffuser (7) has a second diameter, and the second diameter is different than the first diameter.

3. The compressor (3) of claim 2 wherein the diffuser wall assembly (30) includes plates (40) arranged about a circumference of the compressor wheel (5), wherein when diffuser wall assembly (30) is in the first position, the plates (40) are located at a first radial distance from the rotational axis (R), and when the diffuser wall assembly (30) is in the second position, the plates (40) are located at a second radial distance from the rotational axis (R), and the second radial distance is different than the first radial distance.

4. The compressor (3) of claim 1, wherein the diffuser wall assembly (30) includes
overlapping plates (40) that cooperate to define a wall of the diffuser (7),
a stationary ring (60) that supports the plates (40) relative to the housing (12), and
a movable ring (80) that is concentric with the stationary ring (60), and is configured to engage each plate (40) such that when the movable ring (80) is rotated about the rotational axis (R) relative to the stationary ring (60), the radial position of the plates (40) is changed.

5. The compressor (3) of claim 4 wherein the plates (40) have a profile in the shape of a sector of an annulus.

6. The compressor (3) of claim 4, wherein
each plate (40) includes a flow surface (41) that faces the facing surface (17a), and an actuating surface (42) that is opposed to the flow surface (41), and
each plate (40) has a thickness that is non-uniform along a circumference of t le plate (40).

7. The compressor (3) of claim 6, wherein each plate (40) includes
a first slide surface (51) formed on the flow surface (41), the first slide surface (51) defining a first region of reduced plate thickness and extending between a first side edge of the plate (40) and a first shoulder,
a second slide surface (53) formed on the actuating surface (42), the second slide surface (53) defining a second region of reduced plate thickness and extending between a second side edge of the plate (40) and a second shoulder, and wherein
the plates (40) are arranged in an overlapping manner about a circumference of the compressor wheel (5) such that the first slide surface (51) of one plate (40a) at least partially overlies the second slide surface (53) of an adjacent plate (40b), regardless of the position of the plates (40).

8. The compressor (3) of claim 4, wherein
each plate (40) includes an alignment slot (47, 48) and an actuating slot (49),
the stationary ring (60) includes first protrusions (65, 66), and a first protrusion is received in the alignment slot (47, 48) of each plate (40),
the movable ring includes second protrusions (85), and a second protrusion is received in the actuating slot (49) of each plate (40), and
when the movable ring is rotated about the rotational axis (R), each second protrusion (85) cooperates with a corresponding actuating slot (49) to cause movement of a corresponding plate (40), and each first protrusion (65, 66) is configured to cooperate with a corresponding alignment slot (47, 48) to direct the movement of the plate (40) in a radial direction.

9. A turbocharger comprising,
a turbine section including a turbine wheel,
a compressor section (3) including a compressor wheel (5), and
a shaft connecting the turbine wheel to the compressor wheel (5),
wherein the compressor section (3) further includes
a housing (12) that surrounds the compressor wheel (5) and defines
an air inlet (16) that is aligned with a rotational axis (R) of the shaft,
an air outlet (18) in fluid communication with the air inlet (16), and
a volute (14) that provides a portion of a fluid path between the air inlet (16) and the air outlet (18), and
a variable diameter diffuser (7) that extends radially between the compressor wheel (5) and the volute (14), and is defined between an adjustable diffuser wall assembly (30) and a facing surface (17a) of the housing (12).

10. The turbocharger of claim 9, wherein the diffuser wall assembly (30) is configured to be adjustable between a first position in which the diffuser (7) has a first diameter, and a second position in which the diffuser (7) has a second diameter, and the second diameter is different than the first diameter.

11. The turbocharger of claim 9, wherein the diffuser wall assembly (30) includes
overlapping plates (40) that cooperate to define a wall of the diffuser (7),
a stationary ring (60) that supports the plates (40) relative to the housing (12), and
a movable ring (80) that is concentric with the stationary ring (60), and is configured to engage each plate (40) such that when the movable ring (80) is rotated about the rotational axis (R) relative to the stationary ring (60), the radial position of the plates (40) is changed.

12. The turbocharger of claim 11 wherein the plates (40) have a profile in the shape of a sector of an annulus.

13. The turbocharger of claim 11, wherein
each plate (40) includes a flow surface (41) that faces the facing surface (17a), and an actuating surface (42) that is opposed to the flow surface (41), and
each plate (40) has a thickness that is non-uniform along a circumference of the plate (40).

14. The turbocharger of claim 13, wherein each plate (40) includes
a first slide surface (51) formed on the flow surface (41), the first slide surface (51) defining a first region of reduced plate thickness and extending between a first side edge of t plate (40) and a first shoulder,
a second slide surface (53) formed on the actuating surface (42), the second slide surface (53) defining a second region of reduced plate thickness and extending between a second side edge of the plate (40) and a second shoulder, and wherein
the plates (40) are arranged in an overlapping manner about a circumference of the compressor wheel (5) such that the first slide surface (51) of one plate (40a) at least partially overlies the second slide surface (53) of an adjacent plate (40b), regardless of the position of the plates (40).

15. The turbocharger of claim 11, wherein
each plate (40) includes an alignment slot (47, 48) and an actuating slot (49),
the stationary ring (60) includes first protrusions (65, 66), and a first protrusion is received in the alignment slot (47, 48) of each plate (40),
the movable ring includes second protrusions (85), and a second protrusion is received in the actuating slot (49) of each plate (40),
when the movable ring is rotated about the rotational axis (R), each second protrusion (85) cooperates with a corresponding actuating slot (49) to cause movement of a corresponding plate (40), and each first protrusion (65, 66) is configured to cooperate with a corresponding alignment slot (47, 48) to direct the movement of the plate (40) in a radial direction.
